(19) United States
(12) Patent Application Publication
(10) Pub. No.: US 2026/0080711 A1
(43) Pub. Date: Mar. 19, 2026

(54) TOUCHLESS INSPECTION METHOD, APPARATUS, AND SYSTEM

(71) Applicant: paymentinapp Inc., Seoul (KR)

(72) Inventor: Junghyung Suh, Seoul (KR)

(21) Appl. No.: 18/896,607

(22) Filed: Sep. 25, 2024

(30) Foreign Application Priority Data
Sep. 13, 2024 (KR) 10-2024-0125771

(51) Int. Cl. G06V 40/16; G06V 10/94; H04N 7/18

(52) U.S. Cl. CPC G06V 40/168; G06V 10/95; G06V 40/172; H04N 7/183

(57) ABSTRACT

The present disclosure discloses a touchless inspection method, apparatus and system. A touchless inspection apparatus includes a processor; and a memory connected to the processor, wherein the memory stores program instructions executed by the processor to perform user approval through biometric information when a user located at a preset checkpoint executes an approval app through his/her mobile to input the biometric information, check whether the user actually exists at the checkpoint using a wireless signal transmitted by the mobile according to a short-range communication protocol after the user approval is completed, and inspect the user identity using a user's face included in an image input through the camera installed around the checkpoint.

### CROSS-REFERENCE TO RELATED APPLICATION

This application claims the benefit of priority under 35 U.S.C. § 119(a) to Korean Patent Application No. 10-2024-0125771 filed on Sep. 13, 2024, the entire contents of which are incorporated herein by reference.

### BACKGROUND

### (a) Technical Field

The present disclosure relates to a touchless inspection method, apparatus, and system, and more particularly, to a method and apparatus capable of inspecting user identity at an airport or the like in a touchless manner.

### (b) Background Art

There are public boarding facilities, such as airports or ports where people can leave the border, as places where security and visitor management are strictly controlled. When using the public boarding facilities, a passport, which is the only document that can guarantee traveler identity overseas, is usually presented along with an immigration declaration form. The passport and immigration declaration form contain information such as name, date of birth, resident registration number, gender, nationality, passport number, residential address, phone number, occupation, company name, travel purpose, departure point, flight number, and signature.

Since identity inspection, etc., of users in such controlled places is conducted in a manner of directly comparing a user identification card and a photo on the user identification card with a user's face, that is, a touch manner, there is a problem in that the inspection time is quite long and it is impossible to find users with stolen IDs, etc.

### SUMMARY OF THE DISCLOSURE

To solve the problem in the above-mentioned related art, the present disclosure is to provide a touchless inspection method, apparatus, and system capable of quickly performing user identity inspection and increasing accuracy of identity inspection.

To achieve the object, according to an aspect of the present disclosure, a touchless inspection apparatus includes: a processor; and a memory connected to the processor, wherein the memory stores program instructions executed by the processor to perform user approval through biometric information when a user located at a preset checkpoint executes an approval app through his/her mobile to input the biometric information, specify a user in a predetermined space using a wireless signal transmitted by the mobile according to a short-range communication protocol and one or more cameras installed around the checkpoint after the user approval is completed, and inspect the user identity using a user's face included in an image input through the one or more cameras for the specified user.

The checkpoint may be designated as a predetermined location such as an airport, a port, a bus, a railway, a conference, a performance hall, and a vehicle entry/exit office.

The biometric information may include at least one of the user's face, an iris, and a fingerprint.

After the user approval is completed, the mobile may transmit a Bluetooth low energy (BLE) signal including entry/exit-related unique identification information according to the BLE protocol.

The entry/exit-related unique identification information may be randomly encrypted and assigned when the user fills out an entry card or purchases a ticket.

Each of a plurality of users located in a predetermined space may be specified using a first user location through the BLE signal and a second user location identified by the camera, and the program instructions may perform user identity inspection by comparing facial feature information of each of the plurality of specified users with pre-stored feature information.

The image for inspecting the user identity may be received from a camera fixedly installed at the checkpoint or a camera attached to a mobile robot that is movable on the checkpoint.

According to another aspect of the present disclosure, a touchless inspection method as a method of authenticating a user in a touchless manner in an apparatus including a processor and a memory includes: performing user approval through biometric information when a user located at a preset checkpoint executes an approval app through his/her mobile to input the biometric information; specifying a user in a predetermined space using a wireless signal transmitted by the mobile according to a short-range communication protocol and one or more cameras installed around the checkpoint, after the user approval is completed; and inspecting the user identity using a user's face included in an image input through the one or more cameras for the specified user.

According to still another aspect of the present disclosure, a touchless inspection system includes: a server that performs user approval through biometric information when a user located at a preset checkpoint executes an approval app through his/her mobile to input the biometric information; and an edge device that specifies a user in a predetermined space using a wireless signal transmitted by the mobile according to a short-range communication protocol and one or more cameras installed around the checkpoint after the user approval is completed and is linked with the server to inspect the user identity using a user's face included in the image input through the camera installed around the checkpoint for the specified user.

According to the present disclosure, since the mobile self clearance at a preset checkpoint, BLE-based location recognition, and user's facial recognition process using vision computing are sequentially performed, it is possible to inspect the user identity quickly and accurately in a touchless manner.

### BRIEF DESCRIPTION OF THE DRAWINGS

FIG. 1 is a diagram illustrating a configuration of a touchless inspection system according to an embodiment of the present disclosure.

FIG. 2 is a diagram illustrating a configuration of a touchless inspection apparatus according to an embodiment of the present disclosure.

FIG. 3 is a diagram illustrating a checkpoint and a wireless signal transmission process according to an embodiment of the present disclosure.

FIG. 4 is a diagram describing a touchless inspection process at a vehicle entry/exit office according to an embodiment of the present disclosure.

FIG. 5 is a diagram illustrating a user location recognition process in a vehicle using a BLE wireless signal according to an embodiment of the present disclosure.

FIG. 6 is a diagram illustrating a vision system-based user inspection process according to an embodiment of the present disclosure.

FIG. 7 is a diagram illustrating a state in which a camera is installed on a mobile robot according to an embodiment of the present disclosure.

FIG. 8 is a flowchart illustrating a flow of a touchless inspection process according to an embodiment of the present disclosure.

### DETAILED DESCRIPTION

Since the present disclosure may be variously modified and have several exemplary embodiments, specific exemplary embodiments will be illustrated in the accompanying drawings and be described in detail in a detailed description. However, it is to be understood that the present disclosure is not limited to a specific embodiment, but includes all modifications, equivalents, and substitutions included within the technical scope and spirit of the present disclosure.

The terms used in the present disclosure are used only in order to describe specific embodiments rather than limiting the present disclosure. Singular forms include plural forms unless the context clearly indicates otherwise. It should be understood that the term “include” or “have” used in the present disclosure is to specify the presence of features, numerals, steps, operations, components, parts mentioned in the present disclosure, or combinations thereof, but does not exclude the presence or addition of one or more other features, numerals, steps, operations, components, parts, or combinations thereof in advance.

In addition, components of the embodiments described with reference to each drawing are not limitedly applied only to the corresponding embodiment, and may be implemented to be included in other embodiments within the scope of maintaining the technical spirit of the present disclosure. In addition, it goes without saying that these components may also be re-implemented as one embodiment in which a plurality of embodiments are integrated, even if a separate description is omitted.

In addition, in the description with reference to the accompanying drawings, regardless of reference numerals, the same components will be given the same or related reference numerals and duplicate description thereof will be omitted. When it is decided that the detailed description of the known art related to the present disclosure may unnecessarily obscure the gist of the present disclosure, a detailed description will be omitted.

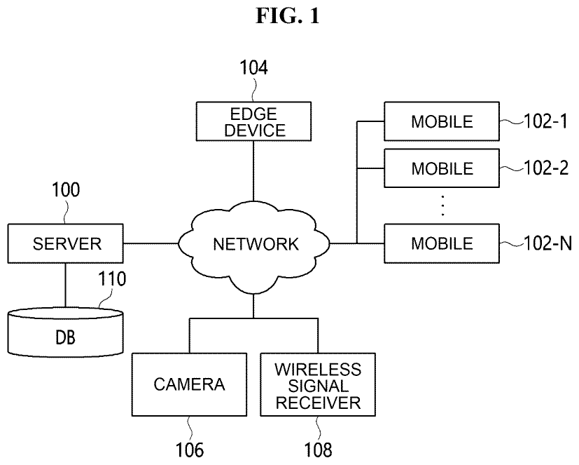

FIG. 1 is a diagram illustrating a configuration of a touchless inspection system according to an embodiment of the present disclosure.

As illustrated in FIG. 1, the system according to an embodiment of the present disclosure may include a server 100, database DB 110, a plurality of mobiles 102-1, 102-2, . . . , 102-N, an edge device 104, a camera 106, and a wireless signal receiver 108.

The server 100 is connected to the plurality of mobiles 102 and the edge device 104 through a network, in which the network may include a wired/wireless communication network, a mobile communication network, a satellite network, and a private network in which security is maintained.

The server 100 according to an embodiment of the present disclosure combines short-range wireless communication through mobile self clearance and the edge device 104 and inspection by AI computer vision to inspect whether a user passing through a restricted space such as an airport, a port, a bus, a railway, a conference, a performance hall, and a vehicle entry/exit office is a user who enters/exits legally. Here, the inspection of whether the user is the legitimate user may include whether the user has filled out an entry card or purchased a ticket to allow the entry/exit.

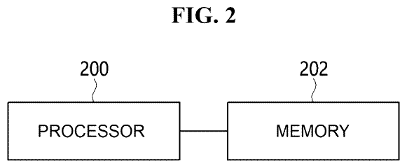

FIG. 2 is a diagram illustrating a detailed configuration of a server for touchless inspection according to an embodiment of the present disclosure, and the server 100 according to the present embodiment may include a processor 200 and a memory 202.

The processor 200 may include a central processing unit (CPU) capable of executing a computer program, other virtual machines, or the like.

The memory 202 may include a non-volatile storage device such as a non-removable hard drive or a removable storage device. The removable storage device may include a compact flash unit, a USB memory stick, and the like. The memory 202 may also include a volatile memory, such as various random access memories.

The memory 202 stores program instructions for inspecting whether a user passing through a restricted space in a touchless manner is a legitimate user.

According to the present embodiment, the server 100 may perform all of the mobile self clearance, individual user identification, and an inspection process through a user's face.

However, after the server 100 performs the mobile self clearance without limitation, the edge device 104 may perform user identification through the camera 106 and the wireless signal receiver 108, transmit feature information about the face of the user whose location is specified to the server 100 by linking with the server 100, and receive inspection completion information through the server 100.

Hereinafter, the edge device 104 according to an embodiment of the present disclosure will be described with a focus on performing the user inspection by linking with the server 100.

The server 100 according to an embodiment of the present disclosure is connected to a user's mobile 102-n (hereinafter, 102) passing through a restricted space and performs approval of a user carrying each mobile.

According to an embodiment of the present disclosure, when the user is located at a preset checkpoint, the server 100 may transmit an app execution alarm to the user's mobile 102, and when the user executes an approval app through his/her mobile to input biometric information, the server 100 performs the user approval by comparing the biometric information pre-registered for the user with the input biometric information.

Here, the biometric information may include a user's face, an iris, a fingerprint, and the like.

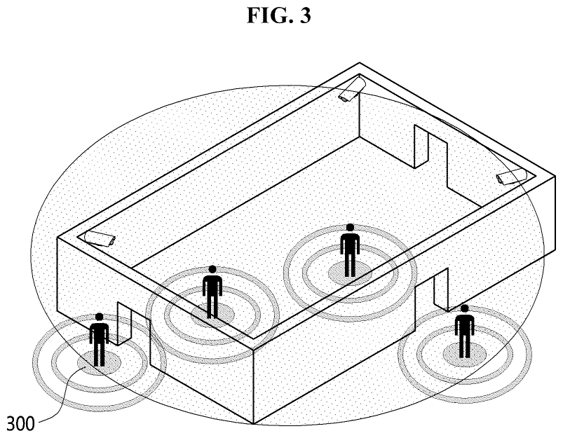

FIG. 3 is a diagram illustrating a checkpoint and a wireless signal transmission process according to an embodiment of the present disclosure.

Referring to FIG. 3, when users are located at a preset checkpoint 300, the server 100 may transmit an approval app execution alarm to users located at the checkpoint 300, and perform the user approval through the biometric information input by the user on the approval app.

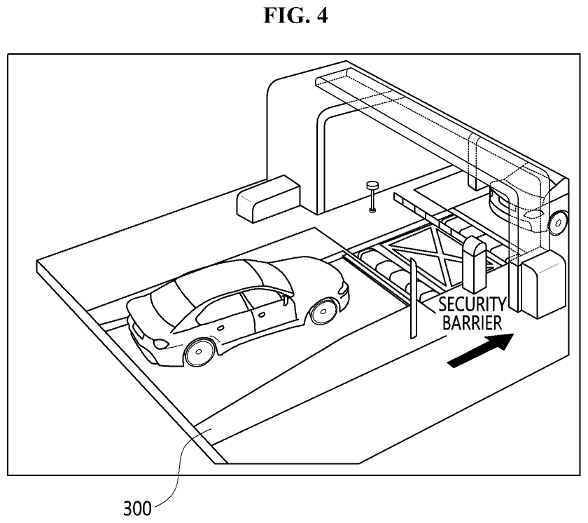

Referring to FIG. 4, when a vehicle is located at a checkpoint 300 of an entry/exit office, the server 100 may transmit an approval app execution alarm to users in the vehicle, and perform user approval through biometric information input by the user on the approval app.

After the user approval is completed, the mobile 102 transmits a wireless signal according to a short-range communication protocol, and the server 100 identifies wireless signals transmitted by each mobile 102 through a wireless signal receiver 108 located around the checkpoint to check whether the user who has performed the mobile self clearance is a user located around the checkpoint.

A database 110 according to the present embodiment stores personal information, biometric information, unique identification information (unique ID (UID)) for each user who passes through an airport, a port, a bus, a railway, a conference, a performance hall, a vehicle entry/exit office, etc., and unique identification information (transaction ID (TID)) related to entry/exit into a predetermined means of transportation or space, the server 100 performs the user approval through the mobile self clearance, and the mobile that has completed the user approval transmits the wireless signal including the TID assigned thereto.

The entry/exit-related unique identification information may be a transaction ID that is randomly encrypted and assigned when the user fills out an entry card or purchases a ticket.

According to the present embodiment, each mobile 102 transmits a BLE signal including the entry/exit-related unique identification information according to a Bluetooth low energy (BLE) protocol, and the wireless signal receiver 108 of FIG. 1 may receive a BLE-based wireless signal.

Referring to FIG. 3, after the user approval is completed at the checkpoint 300, when a user moves, the mobile 102 carried by the user transmits a wireless signal, and the edge device 104 may specify locations of each of the plurality of users located in a predetermined space by receiving wireless signals through one or more wireless signal receivers located in a predetermined area.

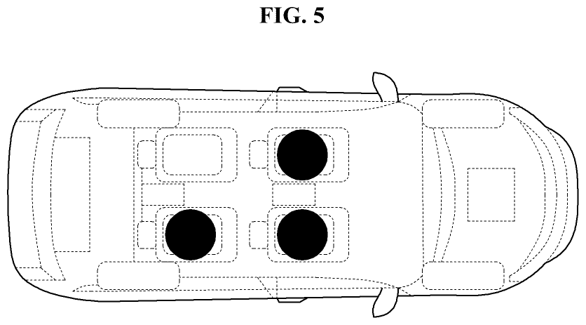

In the case of the vehicle, as illustrated in FIG. 5, the edge device 104 may receive wireless signals from the mobiles 102 carried by users sitting in each seat through the wireless signal receiver 108 located around the vehicle, so the edge device 104 specifies users who have completed the mobile self clearance by linking with the server 100.

According to an embodiment of the present disclosure, the edge device 104 may specify users corresponding to individual TIDs by using a first user location using the wireless signal and a second user location through a camera located around the checkpoint. That is, the edge device 104 calculates the first user location of the user transmitting each signal through the intensity of the BLE wireless signal received by one or more wireless signal receivers 108 and the second user location using the location, angle of the camera installed around the checkpoint or the position of the mobile robot, and specifies each of the plurality of users located in a predetermined space through the calculated first user location and second user location.

Thereafter, the edge device 104 extracts feature information on the user's face input through the camera 106 by the computer vision, and transmits the extracted feature information and the entry/exit-related unique identification information to the server 100 to request a comparison at the server 100.

When the server 100 determines that the facial feature information of each of the plurality of users whose locations have been specified is identical to the pre-stored feature information, the edge device 104 receives the determination result and finally permits the user's entry/exit.

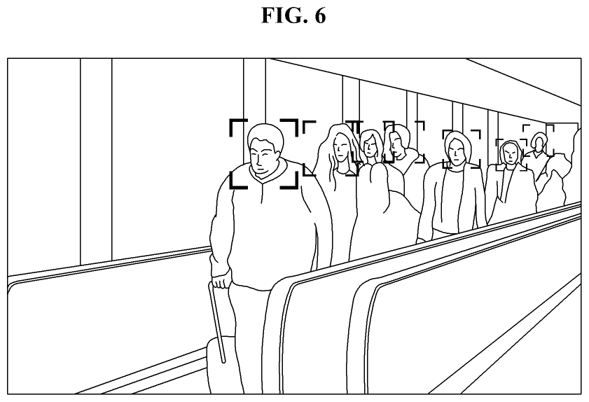

Referring to FIG. 6, after the mobile self clearance and user identification are completed, when an image including the user's face is obtained through a fixedly installed CCTV, etc., the server 100 may compare the mobile self clearance and the face of the user whose location have been specified with the face input through the camera 106 on a 1:1 basis, thereby significantly reducing the user inspection time. That is, there is a problem in that the facial recognition using the existing CCTV not only has a low recognition rate, but is also inefficient because it uses a 1:N search method of comparing the facial information recognized by the camera with a large number n (tens of millions or more in the case of immigration) registered on the server. However, when the method according to an embodiment of the present disclosure is used, it is possible to increase the efficiency of the user identity inspection.

According to an embodiment of the present disclosure, the server 100 is linked with the database 110 to compare whether the user who inputs the biometric information and the user input through the camera 106 are the same person based on AI vision and edge computing for user identity inspection.

Here, the image for inspecting the user identity may be received from a camera fixedly installed at the checkpoint or a camera attached to a mobile robot that is movable on the checkpoint.

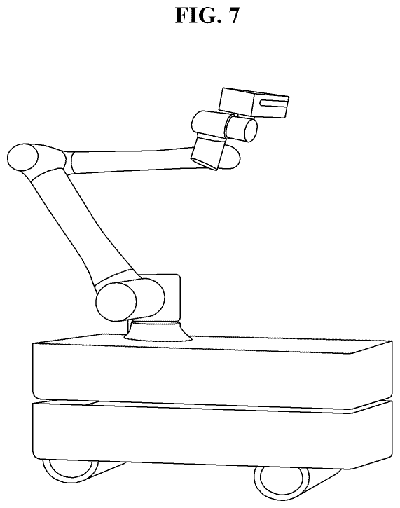

In the case where many users are located in a predetermined space or move through a vehicle, the camera 106 attached to the mobile robot may capture the user's face as illustrated in FIG. 7 to improve the image quality, so the server 100 may perform the inspection process through the user's face more accurately.

The mobile robot according to the present embodiment may be provided with not only a camera but also a metal detector for checking for dangers carried by the user.

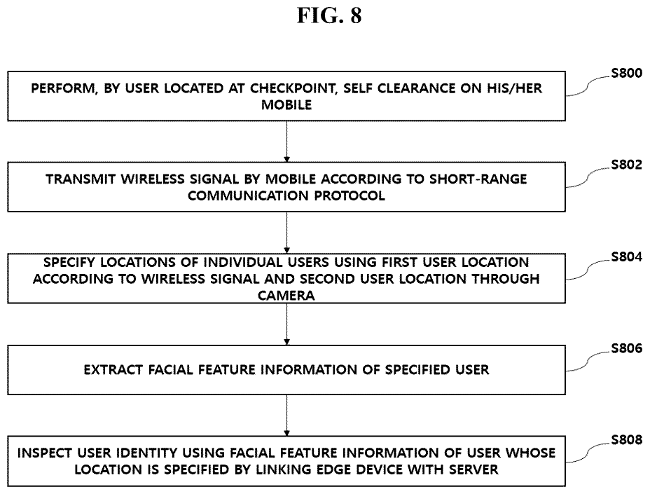

FIG. 8 is a flowchart illustrating a flow of a touchless inspection process according to the present embodiment.

FIG. 8 is a diagram illustrating the process in which the edge device performs the user inspection by linking with a server.

Referring to FIG. 8, each user performs the self clearance on his/her mobile when located at the checkpoint (step 800).

As described above, the mobile self clearance may be performed by the process of executing the approval app on the mobile 102, inputting the user biometric information, and approving the biometric information on the server 100.

After the user approval is completed, each mobile 102 transmits the wireless signal according to the short-range wireless communication protocol (step 802).

As described above, when the user approval is completed using the biometric information in the approval app, each mobile 102 may transmit the BLE signal including the entry/exit-related unique identification information such as the TID.

Thereafter, the edge device 104 specifies the locations of individual user using the first user location according to the wireless signal and the second user location through the camera (step 804) and extracts the facial feature information of the specified user (step 806).

The edge device 104 inspects user identity for an individual user whose location is specified by linking with server 100 (step 808).

In step 808, the edge device 104 transmits the facial feature information and TID information of the individual user to the server 100, and the server 100 compares the pre-stored feature information for the user corresponding to the TID with the feature information transmitted by the edge device 104, and when the comparison result is determined to be the same user, transmits the determination result to the edge device 104.

By receiving the determination result, the edge device 104 finally permits the entry/exit of the user.

Thereafter, the server 100 compares the user's face included in the image input through the camera with the user's face stored in the database 110 to finally inspect the user identity (step 808).

As described above, the camera according to the present embodiment may be fixedly installed at the checkpoint or the camera may be attached to the mobile robot that may move around the checkpoint.

The embodiments of the present disclosure described above have been disclosed for illustrative purposes, and those skilled in the art with ordinary knowledge of the present disclosure will be able to make various modifications, changes, and additions within the spirit and scope of the present disclosure, and these modifications, changes, and additions should be regarded as falling within the scope of the following claims.

What is claimed is:

1. A touchless inspection apparatus, comprising:
a processor; and
a memory connected to the processor,
wherein the memory stores program instructions executed by the processor to perform user approval through biometric information when a user located at a preset checkpoint executes an approval app through the user's mobile to input the biometric information,
specify the user in a predetermined space using a wireless signal transmitted by the user's mobile according to a short-range communication protocol and one or more cameras installed around the predetermined space after the user approval is completed, and
inspect user identity using facial features included in an image input through the one or more cameras.

2. The touchless inspection apparatus of claim 1, wherein the preset checkpoint includes at least one of an airport, a port, a bus, a railway, a conference, a performance hall, and a vehicle entry/exit office.

3. The touchless inspection apparatus of claim 1, wherein the biometric information includes at least one of facial features, irises, and fingerprints.

4. The touchless inspection apparatus of claim 1, wherein after the user approval is completed, the user's mobile transmits a Bluetooth low energy (BLE) signal including entry/exit-related unique identification information according to the BLE protocol.

5. The touchless inspection apparatus of claim 4, wherein the entry/exit-related unique identification information is a transaction ID that is randomly encrypted and assigned when the user fills out an entry card or purchases a ticket.

6. The touchless inspection apparatus of claim 4, wherein each of a plurality of users located in the predetermined space is specified using a first user location through the BLE signal and a second user location identified by the one or more camera, and the program instructions perform user identity inspection by comparing facial feature information of each of the plurality of users with pre-stored facial feature information.

7. The touchless inspection apparatus of claim 1, wherein the image for inspecting a user identity is received from a camera fixedly installed at the preset checkpoint or a camera attached to a mobile robot that is movable on the preset checkpoint.

8. A touchless inspection method for authenticating a user in a touchless manner in an apparatus including a processor and a memory, the touchless inspection method comprising:
performing user approval through biometric information when a user located at a checkpoint executes an approval app through a mobile to input the biometric information;
specifying the user in a predetermined space using a wireless signal transmitted by the mobile according to a short-range communication protocol and one or more cameras installed around the checkpoint after the user approval is completed; and
inspecting user identity using facial features included in an image input through the one or more cameras.

9. The method of claim 8, wherein after the user approval is completed, the mobile transmits a Bluetooth low energy (BLE) signal including entry/exit-related unique identification information according to the BLE protocol.

10. The method of claim 9, wherein each of a plurality of users located in the predetermined space is specified using a first user location through the BLE signal and a second user location identified by the one or more cameras, and
the inspecting of the user identity includes performing user identity inspection by comparing facial feature information of each of the plurality of users with pre-stored facial feature information.

11. The method of claim 9, wherein the inspecting of the user identity includes receiving an image input from a camera fixedly installed at the checkpoint or a camera attached to a mobile robot that is movable on the checkpoint.

12. A touchless inspection system, comprising:
a server that performs user approval through biometric information when a user located at a preset checkpoint executes an approval app through a mobile to input the biometric information; and
an edge device that specifies a user in a predetermined space using a wireless signal transmitted by the mobile according to a short-range communication protocol and one or more cameras installed around the checkpoint after the user approval is completed and is linked with the server to inspect user identity using facial feature included in an image input through the one or more cameras installed around the checkpoint.
